(19) United States
(12) Patent Application Publication
(10) Pub. No.: US 2005/0011610 A1
(43) Pub. Date: Jan. 20, 2005

(54) Bookbinding adhesive forming device and method

(76) Inventor: Robert Louis Cobene II, Santa Clara, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/621,489

(22) Filed: Jul. 18, 2003

(51) Int. Cl. B32B 31/20

(52) U.S. Cl. 156/308.2

(57) ABSTRACT

An apparatus and method for adhesive binding and assembly of plural sheets with a backed hot melt adhesive sheet to form a book-like structure. Exemplary embodiments include a device for contacting the backed hot melt adhesive sheet to a spine surface of the assembly of plural sheets, applying force to an area where the backed hot melt adhesive sheet contacts the assembly of plural sheets, and actively withdrawing heat from the backed hot melt adhesive sheet to bring a temperature of a hot melt adhesive of the backed hot melt adhesive sheet below a glass transition temperature of the hot melt adhesive.

### BACKGROUND

Bookbinding systems can deliver bound documents, including books, manuals, publications, annual reports, newsletters, business plans and brochures. A bookbinding system can be classified as a commercial (or trade) bookbinding system that is designed for in-line manufacturing of high quality volume runs or an office (or in-house) bookbinding system designed for short “on demand” runs. Commercial bookbinding systems can provide a wide variety of binding capabilities in terms of sizes of books, but involve large production runs (e.g., on the order of thousands of books) to offset the set-up cost of each production run and to support the investment in automatic in-line production equipment. Office bookbinding systems, on the other hand, can involve manual intervention and provide relatively few binding capabilities. However, office bookbinding systems can be less expensive to set up and operate than commercial bookbinding systems, even for short on-demand production runs of only a few books.

A bookbinding system collects a plurality of sheets (or pages) into a text body (or book block) that includes a spine and two hinge areas. The bookbinding system applies an adhesive to the text body spine to bind the sheets together. A cover may be attached to the bound text body by an adhesive on the side hinge areas or the spine of the text body, or both. The cover of a commercial soft cover book can be attached to the text spine. The covers of hardcover books and some soft cover “lay flat” books, on the other hand, are not attached to the text body spines (for example, the spines are floating).

The covers can be attached by an adhesive applied to the spine area of the text body. Application of the adhesive and/or cover can be supplemented by exerting force against the spine area. For example, a roller or set of rollers can press against the spine area and apply pressure to an adhesive, such as a softened hot melt adhesive or a room temperature adhesive. However, the rollers can have a failure mode where the adhesive generates a localized buckle, accumulation or wrinkle as the roller travels over the adhesive. The localized buckle, accumulation or wrinkle can become unstable and softened adhesive can flow from the end, contacting the rollers. Also, softened adhesive can build up and result in an inconsistent adhesive bond at the spine. Further, the applied adhesive sets over a period of time. Manipulation of the covered assembly prior to the set of the adhesive can result in pages being separated or misaligned and adhesive residue on equipment.

One known binding technique discloses a cover with an adhesive strip disposed along a spine area is positioned across a pair of pressing rollers to form a pocket with the spine area at the bottom. A text body is inserted into the pocket so that edges of the text body are in contact with the adhesive strip. The pressing rollers are moved forcibly toward one another to compress the cover against the front and back sides of the text body and to compress the text body together adjacent to the spine area. A sonic tool transmits sonic energy (for example, vibratory pressure) through the spine area of the cover to activate the adhesive strip, thereby binding the text body and the cover into a bound book.

Other known binding techniques disclose applying adhesive and/or covers in bookbinding processes. For example, one technique preheats the sheet bundle and preheats the bind tape. In another example, movable shift members have heaters for heating a bind tape. A main heater in a first shift member preheats the bind tape and applies heating and pressure to urge the bind tape against a bound edge of a sheet bundle. Side heaters in side shift members apply heating and pressure to bent side portions of the bind tape.

Finally, a known bookbinding system and a method of binding sheets into a bound text has a tool carrier with separate sides respectively supporting an adhesive heater, an adhesive former and an adhesive cooler. Also, a known bookbinding system and method of dispensing adhesive in a bookbinding system has an adhesive dispenser that dispenses solid sheet adhesive across the thickness of a text body spine.

### SUMMARY

An exemplary embodiment of an apparatus for adhesive binding an assembly of plural sheets with a backed hot melt adhesive sheet to form a book-like structure comprises means for contacting the backed hot melt adhesive sheet to a spine surface of the assembly of plural sheets, the contacting means having a contacting surface for contacting the spine surface, and the spine surface being perpendicular to a planar surface of the assembly of plural sheets, means for applying force to the planar surface in an area where the backed hot melt adhesive sheet contacts the planar surface, the force applying means being mounted for movement with the contacting means, and means for actively withdrawing heat from the backed hot melt adhesive sheet to bring a temperature of a hot melt adhesive of the backed hot melt adhesive sheet to below a glass transition temperature of the hot melt adhesive.

An exemplary method of binding an assembly of plural sheets to form a book-like structure comprises contacting a translatable first contacting surface to a backed hot melt adhesive sheet located on a spine surface of the assembly of plural sheets, the spine surface being perpendicular to a planar surface of the assembly of plural sheets, applying force with at least a translatable second contacting surface to the planar surface in an area where the backed hot melt adhesive sheet contacts the planar surface, and actively withdrawing heat from the backed hot melt adhesive sheet to bring a temperature of a hot melt adhesive of the backed hot melt adhesive sheet to below a glass transition temperature of the hot melt adhesive.

### BRIEF DESCRIPTION OF THE DRAWING FIGURES

The following detailed description of preferred embodiments can be read in connection with the accompanying drawings in which like numerals designate like elements and in which:

FIG. 1 shows an exemplary embodiment of an apparatus for adhesive binding an assembly of plural sheets with a backed hot melt adhesive sheet to form a book-like structure.

FIG. 2 shows an exemplary embodiment of an apparatus for adhesive binding an assembly of plural sheets with a backed hot melt adhesive sheet to form a book-like structure.

FIGS. 3A-3D illustrates the operation of the exemplary apparatus of FIG. 1.

FIGS. 4A-4D illustrates the operation of the exemplary apparatus of FIG. 2.

### DETAILED DESCRIPTION OF THE PREFERRED EMBODIMENTS

An exemplary apparatus for adhesive binding an assembly of plural sheets with a backed hot melt adhesive sheet to form a book-like structure comprises means for contacting the backed hot melt adhesive sheet to a spine surface of the assembly of plural sheets, the contacting means having a contacting surface for contacting the spine surface, and the spine surface being perpendicular to a planar surface of the assembly of plural sheets.

The contacting means can be any suitable means for contacting the spine surface. For example, the contacting means can be a suitable press, mold, surface, platen, forming plate or multiple presses, molds, surfaces, platens, forming plates, or any other suitable means that has a pressure surface that the contacts the spine surface, e.g., the contacting means has a pressure surface or multiple surfaces which can contact the entire spine surface or a majority, e.g., greater than 50%, either contiguous or non-contiguous, of the spine surface of the book-like structure. In one exemplary aspect, the entire spine surface of the book-like structure is encompassed by the contacting means simultaneously.

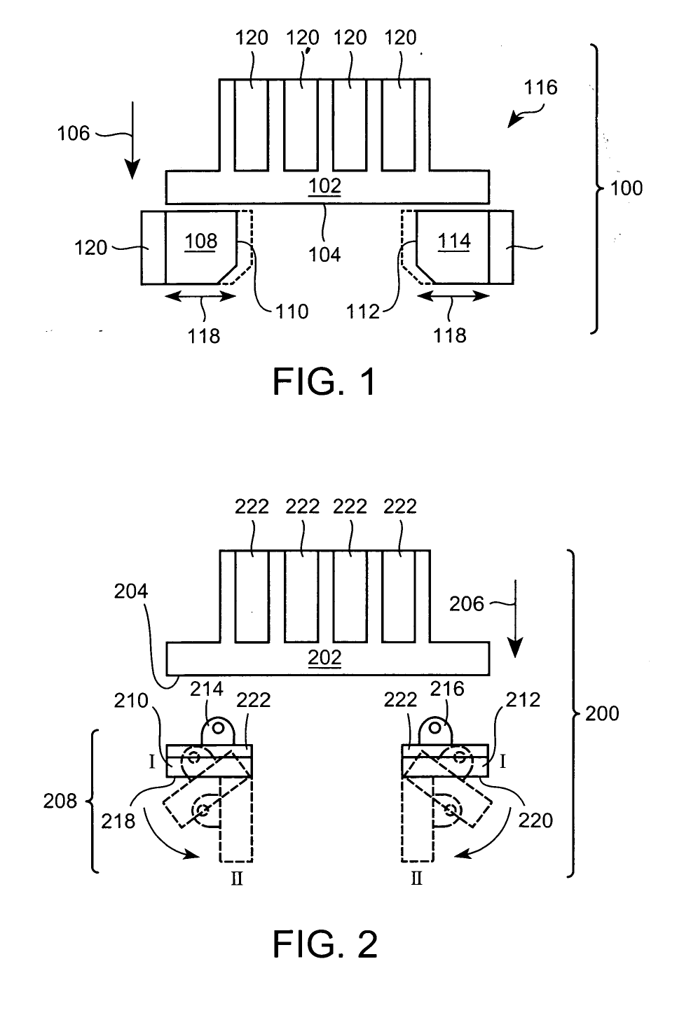

In the exemplary embodiment of an apparatus for adhesive binding an assembly of plural sheets with a backed hot melt adhesive sheet to form a book-like structure shown in FIG. 1, the contacting means includes a contacting surface, such as a platen. For example, the apparatus 100 includes a platen 102. The platen 102 can have a contacting surface 104 oriented parallel to a spine surface of the assembly of plural sheets. The contacting surface can be planar or any suitable conformal shape to the surface to be contacted, including curved, peaked, and other spine surface shapes. The platen 102 is translatable in a first direction 106. Translation can be in a manual manner, by mechanical mechanisms or other types of devices used in mechanical actuation, or a combination of such methods. During a bookbinding operation, the platen 102 of the exemplary embodiment shown in FIG. 1 is at least coextensive with a major length of the spine surface in a dimension parallel to the spine surface.

An exemplary apparatus includes means for applying force to the planar surface in an area where the backed hot melt adhesive sheet contacts the planar surface, the force applying means being mounted for movement with the contacting means. The force applying means can be any suitable means that contacts and applies a force to the planer surface of the book-like structure. For example, the force applying means can be a press, vice, or other suitable force applying means. In an exemplary embodiment, the force applying means applies a force in the area of the planer surface where the backed hot melt adhesive sheet contacts the planer surface.

In the exemplary embodiment of an apparatus for adhesive binding an assembly of plural sheets with a backed hot melt adhesive sheet to form a book-like structure shown in FIG. 1, the force applying means includes at least two clamping bodies. A first clamping body 108 has an opposing surface 110 oriented parallel to and facing an opposing surface 112 of a second clamping body 114. At least one of the clamping bodies 108, 114 is at least coextensive with a major length of the spine surface in a dimension parallel to the spine surface.

In a bookbinding operation, the opposing surfaces 110, 112 of the clamping bodies 108, 114 are oriented toward a planar surface of a sheet of the assembly of plural sheets. The opposing surfaces 110, 112 of the clamping bodies 108, 114 are translatable to an engaged position to apply force to the sheet of the assembly of plural sheets. Translation can be in a manual manner, by mechanical mechanisms or other types of devices used in mechanical actuation, or a combination of such methods. For example, the opposing surfaces 110, 112 of the clamping bodies 108, 114 can be translatable normal to a planar surface of a sheet of the assembly of plural sheets by translational motion in a second direction. Translation can be in a manual manner, by mechanical mechanisms or other types of devices used in mechanical actuation, or a combination of such methods. The translational motion can result in an opposing surface applying a force, e.g., at least a neutral force and preferably at least a force resulting from 5-10 psi pressure, to the sheet of the assembly of plural sheets. At least a portion of the backed hot melt adhesive can be positioned between the contacting surface and the sheet. Further, the clamping bodies 108, 114 are non-rotating and/or are non-rolling, e.g, each clamping body does not change an orientation about an axis through a portion of the clamping body.

In an exemplary embodiment, the force applying means is mounted for movement with the contacting means. The force applying means operates to apply a force to the planer surface in the area where the backed hot melt adhesive sheet contacts the planer surface either sequentially or simultaneously with the movement of the contacting means.

For example and as shown in the exemplary embodiment of FIG. 1, the platen 102 and the at least two clamping bodies 108, 114 can form a clamping jaw 116. The clamping jaw 116 is translatable in the first direction 106 toward the spine surface. Translation can be in a manual manner, by mechanical mechanisms or other types of devices used in mechanical actuation, or a combination of such methods. The at least two clamping bodies 108, 114 are translatable in a second direction 118 to move a first of the opposing surfaces 110, 112 towards or away from a second of the opposing surfaces 110, 112. Translation can be in a manual manner, by mechanical mechanisms or other types of devices used in mechanical actuation, or a combination of such methods. In the exemplary embodiment, the first direction 106 is perpendicular to the second direction 118. Further, the movement in the first direction 106 and in the second direction 118 can be either sequential or simultaneous.

An exemplary apparatus includes means for actively withdrawing heat from the hot melt adhesive of the backed hot melt adhesive sheet to bring a temperature of a hot melt adhesive of the backed hot melt adhesive sheet below a glass transition temperature of the hot melt adhesive. Any suitable means that causes a temperature differential between the means for actively withdrawing heat and the hot melt adhesive of the backed hot melt adhesive sheet can be used. For example, means for actively withdrawing heat can be a Peltier device, such as a solid state heat pumps that operate on the Peltier effect. A device with internal circulation of a cooling medium, such as a liquid, a gas, or an expanding gas can be used. Further, actively withdrawing heat can be by any suitable method, including convective, radiative and forced cooling. Additional suitable means include a Joule-Thomson device. For example, a device in which a temperature drop accompanies the throttling process of an expanding compressed gas or the Joule-Thomson effect can be used.

In the exemplary embodiment of an apparatus for adhesive binding an assembly of plural sheets with a backed hot melt adhesive sheet to form a book-like structure shown in FIG. 1, the means for actively withdrawing heat includes at least one active heat sink 120 in thermal communication with at least one of the platen 102 and the at least to clamping bodies 108, 114 to withdraw heat from the hot melt adhesive of the backed hot melt adhesive sheet. During a bookbinding operation, the active heat sink 120 changes a temperature of a hot melt adhesive of the backed hot melt adhesive sheet below a glass transition temperature of the hot melt adhesive. For example, the hot melt adhesive can be at a temperature above a glass transition temperature, preferably above a melting temperature or other temperature to flow the hot melt adhesive. For example, a temperature at or above 350° F. can be used for a polyester thermal bond film, such as Thermo-Bond® film 615 produced by 3M Corporation, when applied to the spine surface. The active heat sink 120 then lowers the temperature by active cooling to a temperature below the glass transition temperature. The temperature below the glass transition temperature to which the hot melt adhesive is cooled is sufficient to cure or solidify the hot melt adhesive. For example, a temperature below 100-120° F. can be used for a polyester thermal bond film, such as Thermo-Bond® film 615 produced by 3M Corporation. In an exemplary embodiment, the active heat sink 120 includes a Peltier device, a device with internal circulation of a cooling medium, or a Joule-Thomson device. The cooling medium can be any suitable cooling medium such as a liquid, a gas, or an expanding gas.

In the exemplary embodiment shown in FIG. 2 of an apparatus for adhesive binding an assembly of plural sheets with a backed hot melt adhesive sheet to form a book-like structure, the contacting means includes a platen. For example, the apparatus 200 includes a platen 202. The platen 202 can have a contacting surface 204 oriented parallel to a spine surface of the assembly of plural sheets. The platen 202 is translatable in a first direction 206. Translation can be in a manual manner, by mechanical mechanisms or other types of devices used in mechanical actuation, or a combination of such methods. During a bookbinding operation, the platen 202 of the exemplary embodiment shown in FIG. 2 is at least coextensive with a major length of the spine surface in a dimension parallel to the spine surface.

FIG. 2 also schematically illustrates an exemplary embodiment of an apparatus including another example of a means for applying force. Means for applying force 208 includes a pivotable first forming plate 210 and a pivotable second forming plate 212. The first forming plate 210 and the second forming plate 212 are each operably configured with a pivot mechanism 214, 216 to individually pivotably move about the assembly of plural sheets from a first position (indicated by I in FIG. 2) to a second position (indicated by II in FIG. 2).

In the first position (I), each of the first and second forming plates 210, 212 has a contacting surface 218, 220 oriented parallel to a spine surface of the assembly of plural sheets. In addition, the first forming plate and the second forming plate 210, 212 in the first position (I) can contact the backed hot melt adhesive. For example, the first and second forming plates 210, 212 can contact a protruding end portion of the backed hot melt adhesive. In the second position (II), the contacting surface 218 of the first forming plate 210 and the contacting surface 220 of the second forming plate 212 opposingly face each other and are each parallel to and facing a planar surface of the assembly of plural sheets in the area where the backed hot melt adhesive sheet contacts the planar surface.

The first and second forming plates 210, 212 are each individually pivotable to maintain contact between the contacting surface 218, 220 and the assembly of plural sheets as the first forming plate 210 and second forming plate 212 individually pivotably move about the assembly of plural sheets from the first position (I) to the second position (II). Further, each of the first and second forming plates 210, 212 is at least coextensive with a major length of the spine surface in a dimension parallel to the spine surface.

In the exemplary embodiment of an apparatus for adhesive binding an assembly of plural sheets with a backed hot melt adhesive sheet to form a book-like structure shown in FIG. 2, the means for actively withdrawing heat includes at least one active heat sink 222. The active heat sink can be in thermal communication with any suitable portion of the apparatus by which heat can be withdrawn from the hot melt adhesive of the backed hot melt adhesive sheet. For example and as shown in FIG. 2, the active heat sink 222 is in thermal communication with at least the platen 202 to withdraw heat from the hot melt adhesive of the backed hot melt adhesive sheet. In another example, at least one of the first and second forming plates 210, 214 can include the means for actively withdrawing heat. In this example, the active heat sink 222 is in thermal communication with at least one of the first forming plate 210 and the second forming plate 212 to withdraw heat from the hot melt adhesive of the backed hot melt adhesive sheet.

During a bookbinding operation, the active heat sink 222 changes a temperature of a hot melt adhesive of the backed hot melt adhesive sheet below a glass transition temperature of the hot melt adhesive. For example, the hot melt adhesive can be at a glass transition temperature, preferably above a melting temperature or other temperature to flow the hot melt adhesive. For example, a temperature at or above 350° F. can be used for a polyester thermal bond film, such as Thermo-Bond® film 615 produced by 3M Corporation, when applied to the spine surface. The active heat sink 222 then lowers the temperature by active cooling to a temperature below the glass transition temperature. The temperature below the glass transition temperature to which the hot melt adhesive is cooled is sufficient to cure or solidify the hot melt adhesive, For example, a temperature below 100-120° F. can be used for a polyester thermal bond film, such as Thermo-Bond® film 615 produced by 3M Corporation. In an exemplary embodiment, the active heat sink 222 includes a Peltier device, a device with internal circulation of a cooling medium, or a Joule-Thomson device. The cooling medium can be any suitable cooling medium such as a liquid, a gas, or an expanding gas.

An exemplary method of binding an assembly of plural sheets to form a book-like structure comprises contacting a translatable first contacting surface to a backed hot melt adhesive sheet located on a spine surface of the assembly of plural sheets. The spine surface is perpendicular to a planar surface of the assembly of plural sheets. The method also comprises applying force with at least a translatable second contacting surface to the planar surface in an area where the backed hot melt adhesive sheet contacts the planar surface. For example, a neutral force or a force resulting from 5-10 psi pressure can be used. The method comprises actively withdrawing heat from the backed hot melt adhesive sheet to bring a temperature of a hot melt adhesive of the backed hot melt adhesive sheet to below a glass transition temperature of the hot melt adhesive.

The second contacting surface is mounted for movement with the first contacting surface. For example and as shown in FIGS. 1 and 2, the second contacting surface, such as the at least two clamping bodies of FIG. 1 or the pivotable first forming plate and pivotable second forming plate of FIG. 2, can be mounted for movement (for example, translation, rotation, pivot, and so forth), with a first contacting surface, such as the platen of FIGS. 1 and 2.

Actively withdrawing heat includes actively withdrawing heat with an active heat sink attached to and in thermal communication with at least one of the first contacting surface and the second contacting surface to solidify or cure the hot melt adhesive. For example, the active heat sink can be attached to at least one of the platen and the at least two clamping bodies of FIG. 1 or the platen and the pivotable first forming plate and pivotable second forming plate of FIG. 2. The active heat sink is in thermal communication with the respective contacting surfaces.

The active heat sink changes a temperature of a hot melt adhesive of the backed hot melt adhesive sheet below a glass transition temperature of the hot melt adhesive. For example, the hot melt adhesive can be at a glass transition temperature, preferably above a melting temperature or other temperature to flow the hot melt adhesive. For example, a temperature at or above 350° F. can be used for a polyester thermal bond film, such as Thermo-Bond® film 615 produced by 3M Corporation, when applied to the spine surface. The active heat sink then lowers the temperature by active cooling to a temperature below the glass transition temperature. The temperature below the glass transition temperature to which the hot melt adhesive is cooled is sufficient to cure or solidify the hot melt adhesive. For example, a temperature below 100-120° F. can be used for a polyester thermal bond film, such as Thermo-Bond® film 615 produced by 3M Corporation. In an exemplary embodiment, the active heat sink includes a Peltier device, a device with internal circulation of a cooling medium, or a Joule-Thomson device. The cooling medium can be any suitable cooling medium such as a liquid, a gas, or an expanding gas.

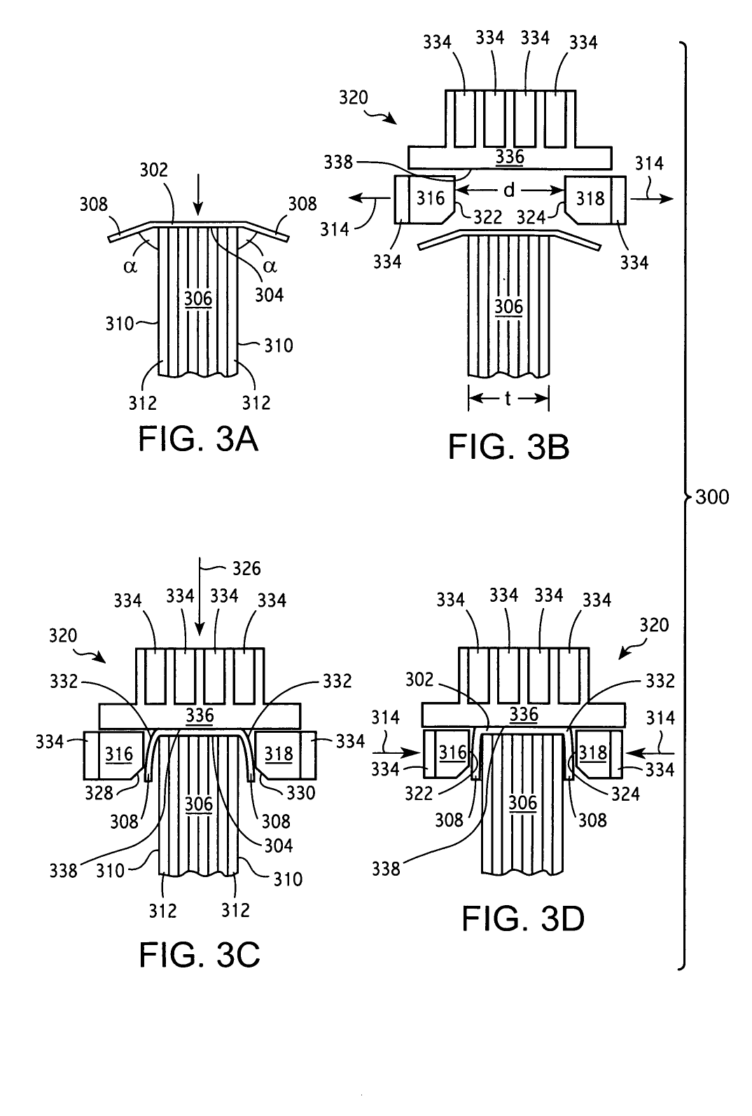

FIGS. 3A-3D illustrate, with respect to the exemplary apparatus depicted and described in FIG. 1, an exemplary method of binding an assembly of plural sheets to form a book-like structure. As shown in FIG. 3A, the exemplary method 300 comprises contacting a backed hot melt adhesive sheet 302 to a spine surface 304 of the assembly of plural sheets 306. The backed hot melt adhesive sheet 302 has at least one end portion 308 protruding past the spine surface 304 and forming an angle α with a plane surface 310 of at least one sheet 312 of the assembly of plural sheets 306.

As shown in FIG. 3B, the exemplary method 300 includes displacing (for example, translating in a first axis 314) a plurality of clamped bodies 316, 318 of a clamping jaw 320 to a separation distance (d) between opposing facing surfaces 322, 324 that is greater than a thickness (t) of the assembly of plural sheets 306.

The exemplary method 300 also includes, as shown in FIG. 3C, displacing (for example, translating in a second axis 326) the clamping jaw 320 relative to the spine surface 304 of the assembly of plural sheets 306 such that at least a portion of the clamping jaw 320 contacts the at least one protruding end portion 308 of the backed hot melt adhesive sheet 302 and redirects the at least one protruding end portion 308 toward the plane surface 310 of the at least one sheet 312 of the assembly of plural sheets 306. For example, a leading edge 328, 330 is adapted to contact a protruding end portion 308 and to redirect the protruding end portion 308 toward the plane surface 310. The leading edge 328, 330 of the clamping jaw 320 can be rounded, chamfered, equipped with guide elements or otherwise suitably configured to contact and slide along the surface 332 of the protruding end portion 308. In the exemplary method, translation can be in a manual manner, by mechanical mechanisms or other types of devices used in mechanical actuation, or a combination of such methods.

FIG. 3D shows the exemplary method 300 including contacting the assembly of plural sheets 306 with the opposing facing surface 322, 324 of at least one of the clamping bodies 316, 318 to apply a force to the assembly of plural sheets 306. Contacting can occur by any suitable manner, including translating the clamping bodies 316,318 in the first axis 314 to apply a force to the assembly of plural sheets 306. For example, a neutral force or a force resulting from 5-10 psi pressure can be used. The at least one protruding end portion 308 is between at least a portion of the opposing facing surface 322, 324 and the assembly of plural sheets 306.

The exemplary method 300 includes absorbing heat from a hot melt adhesive into at least a portion of the clamping jaw 320. Absorbing heat includes actively removing heat from the hot melt adhesive with a heat sink 334, such as a Peltier device, a device with internal circulation of a cooling medium, or a Joule-Thomson device. The cooling medium can include a liquid, a gas, or an expanding gas. Absorbing heat solidifies or cures the hot melt adhesive of the backed hot melt adhesive sheet 302.

In an exemplary method, contacting the backed hot melt adhesive 302 to a spine surface 304 can be by any suitable technique. For example, the hot melt adhesive of the backed hot melt adhesive sheet 302 can be softened prior to the backed hot melt adhesive sheet 302 contacting the spine surface 304 of the assembly of plural sheets 306. In another example, the backed hot melt adhesive sheet is attached to the spine surface at discrete points, e.g., tacked, glued, adhesively or mechanically attached, and then softened. Softening includes raising a temperature of the hot melt adhesive above a glass transition temperature, preferably above a melting temperature or other temperature to flow the hot melt adhesive, e.g., at or above 350° F. for a polyester thermal bond film, such as Thermo-Bond® film 615 produced by 3M Corporation. The softened hot melt adhesive can flow into the assembly of plural sheets 306. For example, the hot melt adhesive flows into at least a portion of the assembly of plural sheets 306 under an external pressure or by capillary action.

In an exemplary method, a separation distance between opposing facing surfaces contacting the assembly of plural sheets sets a thickness of the bound book-like structure. For example, the separation distance (d) between opposing facing surfaces 322, 324 of the displaced clamping bodies 316, 318 can be approximately 20% (for example, 20% ±10%) greater than the thickness (t) of the assembly of plural sheets 306. After displacing the clamping jaw 320 and contacting the assembly of plural sheets 306, the separation distance (d′, where d′≦d) sets a thickness (t′, where t′≦t) of the bound book-like structure in a cross-section taken along the spine.

The portion of the clamping jaw 320 that absorbs heat from the hot melt adhesive is at least one of the clamping bodies 316, 318. However, any suitable portion of the clamping jaw 320 that contacts the backed hot melt adhesive sheet 302 or is in thermal communication with the hot melt adhesive can be used to absorb the heat, e.g., the platen 336, the clamping bodies 316, 318, and/or combinations of portions thereof. For example, at least a portion of one of the clamping bodies 316, 318 and/or any portion of the clamping jaw 320 that absorbs heat from the hot melt adhesive can be coupled with a heat sink 334. The heat sink 334 can be either active, passive, or combination thereof. Examples of suitable active heat sinks include a Peltier device, a device with internal circulation of a cooling medium, or a Joule-Thomson device.

An exemplary method of binding an assembly of plural sheets to form a book-like structure can comprise contacting a platen 336 of a clamping jaw 320 to the backed hot melt adhesive sheet 302 contacting the spine surface 304. The platen 336 has a contacting surface 338 parallel to the spine surface 304. The portion of the clamping jaw 320 that absorbs heat from the hot melt adhesive can include the platen 336.

In an exemplary method, contacting the assembly of plural sheets 306 with the opposing facing surface 322, 324 of at least one of the clamping bodies 316, 318 and contacting a platen 336 of the clamping jaw 320 to the backed hot melt adhesive sheet 302 can occur simultaneously. In embodiments where the platen 336 and the opposing facing surfaces 322, 324 of the clamping bodies 316, 318 are coextensive with the spine surface 304 in a direction parallel to the spine surface 304, a majority (for example, greater than 50%) and preferably the entire backed hot melt adhesive sheet 302 is simultaneously contacted by the clamping jaw 320. During contacting, at least a neutral force and preferably at least a force resulting from 5-10 psi pressure, is applied to the assembly of plural sheets 306. This force can be applied during the entire solidification or curing period, or during a portion thereof.

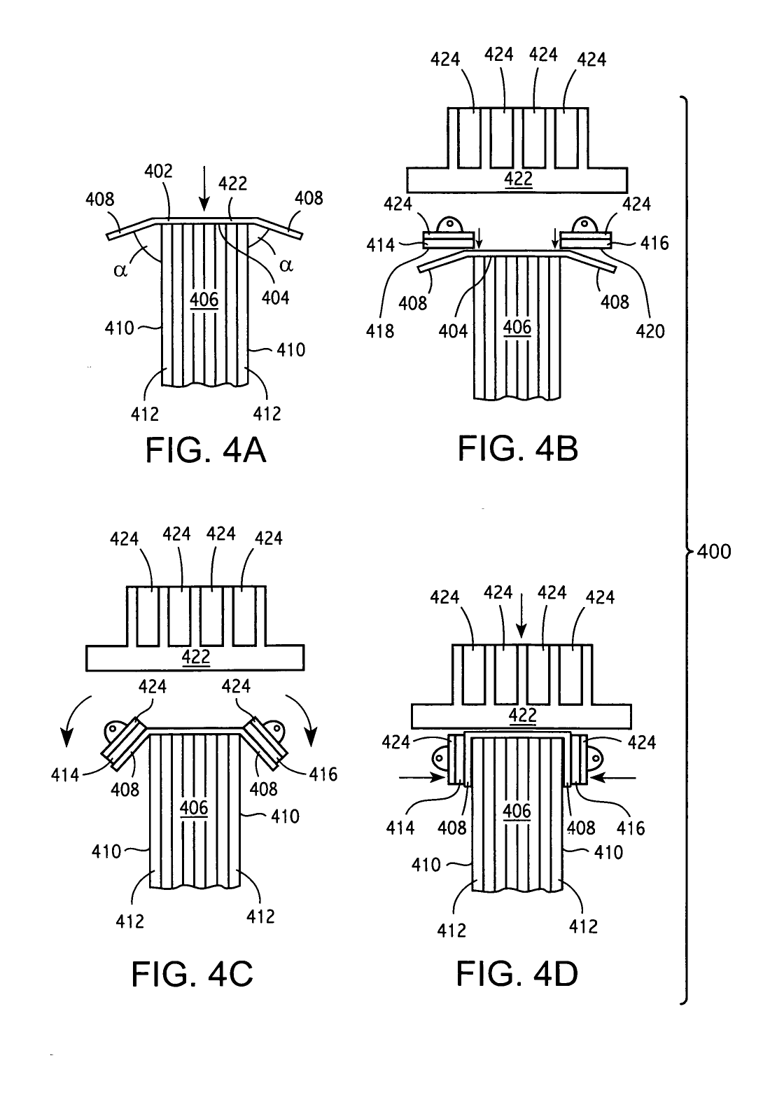

FIGS. 4A to 4D illustrate, with respect to the exemplary apparatus depicted and described in FIG. 2, an exemplary method of binding an assembly of plural sheets to form a book-like structure. As shown in FIG. 4A, the exemplary method 400 comprises contacting a backed hot melt adhesive sheet 402 to a spine surface 404 of the assembly of plural sheets 406. The backed hot melt adhesive sheet 402 has at least one end portion 408 protruding past the spine surface 404 and forming an angle α with a plane surface 410 of at least one sheet 412 of the assembly of plural sheets 406.

The exemplary method 400 as shown in FIG. 4B includes displacing (for example, translating in a first axis) a first forming plate 414 and a second forming plate 416 relative to the spine surface 404 of the assembly of plural sheets 406 to a first position. In the first position, each of the first and second forming plates 414, 416 has a contacting surface 418, 420 oriented parallel to the spine surface 404 of the assembly of plural sheets 406. At least a portion of each of the first forming plate 414 and the second forming plate 416 contacts the backed hot melt adhesive sheet 402. In the exemplary method, translation can be in a manual manner, by mechanical mechanisms or other types of devices used in mechanical actuation, or a combination of such methods.

FIGS. 4C to 4D show the exemplary method 400 also includes individually pivotably moving the first forming plate 414 and the second forming plate 416 about the assembly of plural sheets 406 from the first position to a second position such that the protruding end portion 408 of the backed hot melt adhesive sheet 402 is redirected toward the plane surface 410 of the at least one sheet 412 of the assembly of plural sheets 406. The protruding end portion 408 is between at least a portion of the contacting surfaces 418, 420 and the assembly of plural sheets 406. In the second position, the contacting surface 418 of the first forming plate 414 and the contacting surface 420 of the second forming plate 416 opposingly face each other and are each parallel to and facing a planar surface of the assembly of plural sheets 406. In an exemplary method, at least a portion of the contacting surface 418 of the first forming plate 414 and at least a portion of the contacting surface 420 of the second forming plate 416 each remain in contact with the backed hot melt adhesive sheet 402 during the separable pivotable moving of the first forming plate 414 and the second forming plate 416 about the assembly of plural sheets 406 from the first position to the second position.

The exemplary method 400 also includes applying a force to the assembly of plural sheets 406 with the opposing facing contacting surface 418, 420 of at least one of the first forming plate 414 and the second forming plate 416.

The exemplary method 400 includes translating a platen 422 from a non-contacting position to a contacting position, as depicted in FIG. 4D. In the non-contacting position, the platen 422 does not contact the backed hot melt adhesive sheet 402. In the contacting position, the platen 422 contacts the backed hot melt adhesive sheet 402. Also, in the contacting position the platen 422 can apply at least a neutral force, preferably at least a force resulting from 5-10 psi pressure, to an assembly of plural sheets 406. In the exemplary method, translation can be in a manual manner, by mechanical mechanisms or other types of devices used in mechanical actuation, or a combination of such methods.

The exemplary method 400 includes absorbing heat from a hot melt adhesive of the backed hot melt adhesive sheet 402 into at least a portion of at least one of the platen 422, the first forming plate 414, and the second forming plate 416. The portion can be any suitable portion, such as a heat sink 424. Absorbing heat includes actively removing heat from the hot melt adhesive with the heat sink 424, such as a Peltier device, a device with internal circulation of a cooling medium, or a Joule-Thomson device. The cooling medium can include a liquid, a gas, or an expanding gas. Absorbing heat solidifies or cures the hot melt adhesive 422.

In an exemplary method, contacting the backed hot melt adhesive 402 to a spine surface 404 can be by any suitable technique. For example, the hot melt adhesive of the backed hot melt adhesive sheet 402 can be softened prior to the backed hot melt adhesive sheet 402 contacting the spine surface 404 of the assembly of plural sheets 406. In another example, the backed hot melt adhesive sheet is attached to the spine surface at discrete points (for example, tacked, glued, adhesively or mechanically attached and then softened). Softening includes raising a temperature of the hot melt adhesive above a glass transition temperature, preferably above a melting temperature or other temperature to flow the hot melt adhesive. For example, a temperature at or above 350° F. can be used for a polyester thermal bond film, such as Thermo-Bond® film 615 produced by 3M Corporation. For example, the softened hot melt adhesive flows into the assembly of plural sheets 406. For example, the hot melt adhesive flows into at least a portion of the assembly of plural sheets 406 under an external pressure or by capillary action.

As referenced herein, a “plural assembly of sheets” refers to either a bound text body (for example, a stack of pages with edges connected together with, for example an adhesive or a mechanical connection) or an unbound text body (for example, a stack of pages with the edges not connected). Further, a plural assembly of sheets does not necessarily have to be bound prior to being contacted with the backed hot melt adhesive sheet and the same hot melt adhesive used in binding the assembly of plural sheets can also be used to attach a cover. The apparatus described herein can be implemented in a desktop or office bookmaking system (for example, designed to satisfy on-demand bookbinding needs), in a mass-production setting, or in any other system where the binding of assemblies of plural sheets is desired.

Although preferred embodiments have been described, it will be appreciated by those skilled in the art that additions, deletions, modifications, and substitutions not specifically described may be made without department from the spirit and scope of the invention as defined in the appended claims.

1. An apparatus for adhesive binding an assembly of plural sheets with a backed hot melt adhesive sheet to form a book-like structure, the apparatus comprising:
means for contacting the backed hot melt adhesive sheet to a spine surface of the assembly of plural sheets, the contacting means having a contacting surface for contacting the spine surface, and the spine surface being perpendicular to a planar surface of the assembly of plural sheets;
means for applying force to the planar surface in an area where the backed hot melt adhesive sheet contacts the planar surface, the force applying means being mounted for movement with the contacting means; and
means for actively withdrawing heat from the backed hot melt adhesive sheet to bring a temperature of a hot melt adhesive of the backed hot melt adhesive sheet to below a glass transition temperature of the hot melt adhesive.

2. The apparatus of claim 1, wherein the means for contacting includes a platen, and the means for applying force includes at least two clamping bodies, the platen and the at least two clamping bodies forming a clamping jaw translatable in a first direction toward the spine surface and the at least two clamping bodies each having an opposing surface, the opposing surfaces being translatable in a second direction to move a first of the opposing surfaces towards or away from a second of the opposing surfaces.

3. An apparatus for adhesive binding an assembly of plural sheets with a backed hot melt adhesive sheet to form a book-like structure, the apparatus comprising:
a platen with a contacting surface oriented parallel to a spine surface of the assembly of plural sheets, the platen being translatable in a first direction;
at least two clamping bodies, a first clamping body having an opposing surface oriented parallel to and facing an opposing surface of a second clamping body; and
an active heat sink attached to and in thermal communication with at least one of the platen and the at least two clamping bodies.

4. The apparatus of claim 3, wherein the active heat sink changes a temperature of a hot melt adhesive of the backed hot melt adhesive sheet to below a glass transition temperature of the hot melt adhesive.

5. The apparatus of claim 3, wherein the active heat sink includes a Peltier device, a device with internal circulation of a cooling medium, or a Joule-Thomson device.

6. The apparatus of claim 5, wherein the cooling medium is a liquid, a gas, or an expanding gas.

7. The apparatus of claim 3, wherein the platen and the at least two clamping bodies form a clamping jaw, the clamping jaw translatable in the first direction toward the spine surface and the at least two clamping bodies translatable in a second direction to move a first of the opposing surfaces towards or away from a second of the opposing surfaces.

8. The apparatus of claim 7, wherein the first direction is perpendicular to the second direction.

9. The apparatus of claim 3, wherein the platen is at least coextensive with a major length of the spine surface in a dimension parallel to the spine surface.

10. The apparatus of claim 3, wherein at least one of the clamping bodies is at least coextensive with a major length of the spine surface in a dimension parallel to the spine surface.

11. The apparatus of claim 3, wherein the opposing surfaces of the clamping bodies are oriented toward a planar surface of a sheet of the assembly of plural sheets.

12. The apparatus of claim 3, wherein the opposing surfaces of the clamping bodies are translatable to an engaged position to apply force to the sheet of the assembly of plural sheets.

13. The apparatus of claim 3, wherein the clamping bodies are non-rotating.

14. The apparatus of claim 3, wherein the clamping bodies are non-rolling.

15. An apparatus for adhesive binding an assembly of plural sheets with a backed hot melt adhesive sheet to form a book-like structure, the apparatus comprising:
a platen;
a first forming plate;
a second forming plate; and
an active heat sink attached to and in thermal communication with at least one of the platen, the first forming plate and the second forming plate,
wherein the first forming plate and second forming plate are individually pivotably moveable about the assembly of plural sheets from a first position to a second position, and
wherein in the first position, each of the first and second forming plates has a contacting surface oriented parallel to a spine surface of the assembly of plural sheets and in the second position, the contacting surface of the first forming plate and the contacting surface of the second forming plate opposingly face each other and are each parallel to and facing a planar surface of the assembly of plural sheets.

16. The apparatus of claim 15, wherein the first and second forming plates are each individually pivotable to maintain contact between the contacting surface and the backed hot melt adhesive sheet as the first forming plate and second forming plate individually pivotably move about the assembly of plural sheets from the first position to the second position.

17. The apparatus of claim 15, wherein each of the first and second forming plates is at least coextensive with a major length of the spine surface in a dimension parallel to the spine surface.

18. The apparatus of claim 15, wherein the platen is at least coextensive with a major length of the spine surface in a dimension parallel to the spine surface.

19. The apparatus of claim 15, wherein the active heat sink includes a Peltier device, a device with internal circulation of a cooling medium, or a Joule-Thomson device.

20. The apparatus of claim 19, wherein the cooling medium is a liquid, a gas, or an expanding gas.

21. The apparatus of claim 15, wherein the active heat sink changes a temperature of a hot melt adhesive of the backed hot melt adhesive sheet to below a glass transition temperature of the hot melt adhesive.

22. The apparatus of claim 21, wherein the temperature below the glass transition temperature is sufficient to cure or solidify the hot melt adhesive.

23. The apparatus of claim 21, wherein the platen is translatable from a non-contacting position to a contacting position, wherein in the non-contacting position the platen does not contact the backed hot melt adhesive sheet and in the contacting position the platen contacts the backed hot melt adhesive sheet.

24. The apparatus of claim 23, wherein the platen in the contacting position applies at least a neutral force to an assembly of plural sheets.

25. The apparatus of claim 24, wherein the force applied to the assembly of plural sheets is at least a result of 5-10 psi pressure.

26. A method of binding an assembly of plural sheets to form a book-like structure, the method comprising:
contacting a translatable first contacting surface to a backed hot melt adhesive sheet located on a spine surface of the assembly of plural sheets, the spine surface being perpendicular to a planar surface of the assembly of plural sheets;
applying force with at least a translatable second contacting surface to the planar surface in an area where the backed hot melt adhesive sheet contacts the planar surface; and
actively withdrawing heat from the backed hot melt adhesive sheet to bring a temperature of a hot melt adhesive of the backed hot melt adhesive sheet to below a glass transition temperature of the hot melt adhesive.

27. The method of claim 26, wherein the second contacting surface is mounted for movement with the first contacting surface.

28. The method of claim 26, wherein actively withdrawing heat includes actively withdrawing heat with an active heat sink attached to and in thermal communication with at least one of the first contacting surface and the second contacting surface to solidify or cure the hot melt adhesive.

29. A method of binding an assembly of plural sheets to form a book-like structure, the method comprising:
contacting a backed hot melt adhesive sheet to a spine surface of the assembly of plural sheets, wherein the backed hot melt adhesive sheet has at least one end portion protruding past the spine surface and forming an angle with a plane surface of at least one sheet of the assembly of plural sheets;
displacing a plurality of clamping bodies of a clamping jaw to a separation distance between opposing facing surfaces that is greater than a thickness of the assembly of plural sheets;
translating the clamping jaw relative to the spine surface of the assembly of plural sheets such that at least a portion of the clamping jaw contacts the at least one protruding end portion of the backed hot melt adhesive sheet and redirects the at least one protruding end portion toward the plane surface of the at least one sheet of the assembly of plural sheets;
contacting the assembly of plural sheets with the opposing facing surface of at least one of the clamping bodies to apply a force to the assembly of plural sheets, wherein the at least one protruding end portion is between at least a portion of the opposing facing surface and the assembly of plural sheets; and
absorbing heat from a hot melt adhesive of the backed hot melt adhesive sheet into at least a portion of the clamping jaw.

30. The method of claim 29, comprising softening the hot melt adhesive of the backed hot melt adhesive sheet prior to the sheet contacting the spine surface of the assembly of plural sheets, wherein softening includes raising a temperature of the hot melt adhesive above a glass transition temperature of the hot melt adhesive.

31. The method of claim 30, wherein at least a portion of the softened hot melt adhesive flows into at least a portion of the assembly of plural sheets.

32. The method of claim 29, comprising attaching the backed hot melt adhesive sheet to the spine surface of the assembly of plural sheets at discrete points and softening the hot melt adhesive of the backed hot melt adhesive sheet, wherein softening includes raising a temperature of the hot melt adhesive above a glass transition temperature of the hot melt adhesive.

33. The method of claim 32, wherein at least a portion of the softened hot melt adhesive flows into at least a portion of the assembly of plural sheets.

34. The method of claim 29, wherein a separation distance between opposing facing surfaces contacting the assembly of plural sheets sets a thickness of the bound book-like structure.

35. The method of claim 29, wherein the clamping jaw includes a platen having a contacting surface parallel to the spine surface of the assembly of plural sheets and the method comprises contacting the platen to the backed hot melt adhesive sheet contacting the spine surface simultaneously with contacting the assembly of plural sheets with the opposing facing surface of at least one of the clamping bodies to apply a force to the assembly of plural sheets.

36. A method of binding an assembly of plural sheets to form a book-like structure, the method comprising:
contacting a backed hot melt adhesive sheet to a spine surface of the assembly of plural sheets, wherein the backed hot melt adhesive sheet has at least one end portion protruding past the spine surface and forming an angle with a plane surface of at least one sheet of the assembly of plural sheets;
translating a first forming plate and a second forming plate relative to the spine surface of the assembly of plural sheets to a first position, wherein in the first position each of the first and second forming plates has a contacting surface oriented parallel to the spine surface of the assembly of plural sheets and at least a portion of each of the first forming plate and the second forming plate contacts the backed hot melt adhesive sheet;
individually pivotably moving the first forming plate and the second forming plate about the assembly of plural sheets from the first position to a second position such that the protruding end portion of the backed hot melt adhesive sheet is redirected toward the plane surface of the at least one sheet of the assembly of plural sheets and is between at least a portion of the contacting surfaces and the assembly of plural sheets, wherein in the second position, the contacting surface of the first forming plate and the contacting surface of the second forming plate opposingly face each other and are each parallel to and facing a planar surface of the assembly of plural sheets;
applying a force to the assembly of plural sheets with the opposing facing contacting surface of at least one of the first forming plate and the second forming plate;
translating a platen from a non-contacting position to a contacting position, wherein in the non-contacting position the platen does not contact the backed hot melt adhesive sheet and in the contacting position the platen contacts the backed hot melt adhesive sheet; and
absorbing heat from a hot melt adhesive of the backed hot melt adhesive sheet into at least a portion of at least one of the first forming plate and the second forming plate.

37. The method of claim 36, comprising softening the hot melt adhesive of the backed hot melt adhesive sheet prior to the sheet contacting the spine surface of the assembly of plural sheets, wherein softening includes raising a temperature of the hot melt adhesive above a glass transition temperature of the hot melt adhesive.

38. The method of claim 37, wherein at least a portion of the softened hot melt adhesive flows into at least a portion of the assembly of plural sheets.

39. The method of claim 36, comprising attaching the backed hot melt adhesive sheet to the spine surface of the assembly of plural sheets at discrete points and softening the hot melt adhesive of the backed hot melt adhesive sheet, wherein softening includes raising a temperature of the hot melt adhesive above a glass transition temperature of the hot melt adhesive.

40. The method of claim 39, wherein at least a portion of the softened hot melt adhesive flows into at least a portion of the assembly of plural sheets

41. The method of claim 36, wherein each of the first forming plate and the second forming plate includes a Peltier device, a device with internal circulation of a cooling medium, or a Joule-Thomson device and wherein absorbing heat includes actively removing heat from the hot melt adhesive with the Peltier device, the device with internal circulation of a cooling medium, or the Joule-Thomson device.

42. The method of claim 36, wherein at least a portion of the contacting surface of the first forming plate and at least a portion of the contacting surface of the second forming plate each remain in contact with the backed hot melt adhesive sheet during the separable pivotable moving of the first forming plate and the second forming plate about the assembly of plural sheets from the first position to the second position.

43. The method of claim 36, wherein the platen in the contacting position applies at least a neutral force to an assembly of plural sheets.

44. The method of claim 36, wherein the force applied to the assembly of plural sheets is at least a result of 5-10 psi pressure.
